(19) United States
(12) Patent Application Publication
(10) Pub. No.: US 2021/0167440 A1
(43) Pub. Date: Jun. 3, 2021

(54) METHOD AND DEVICE FOR CONTROLLING THE TEMPERATURE OF A BATTERY ASSEMBLY

(71) Applicant: FAHRENHEIT GMBH, München (DE)

(72) Inventors: Walter Mittelbach, Freiburg (DE); Ralph Herrmann, Halle (DE)

(21) Appl. No.: 16/639,472

(22) PCT Filed: Aug. 6, 2018
(86) PCT No.: PCT/EP2018/071247

§ 371 Date: Feb. 14, 2020

(30) Foreign Application Priority Data
Aug. 18, 2017 (DE) 10 2017 118 949.1
Sep. 29, 2017 (DE) 10 2017 122 724.5

(51) Int. Cl. H01M 10/6552; H01M 10/613; H01M 10/615; H01M 10/625; H01M 10/6568; H01M 10/6569; H01M 10/659; H01M 10/663; B60R 16/033; B60H 1/00; B60H 1/32

(52) U.S. Cl. CPC H01M 10/6552; H01M 10/613; H01M 10/615; H01M 10/625; H01M 10/6568; H01M 2220/20; H01M 10/659; H01M 10/663; B60R 16/033; B60H 1/00278; B60H 1/32014; H01M 10/6569

(57) ABSTRACT

The invention relates to a method for controlling the temperature of a battery assembly, wherein the battery assembly is thermally coupled to an integrated sorption heat storage means. In a desorption phase of the sorption heat storage means, a heating of the sorption material occurs with a desorption of a fluid during a heat output of the battery assembly during an electrical discharging and/or electrical charging. A condensation of the fluid desorbed from the sorption material occurs in a condenser with a heat sink. An independent heating of the battery can be carried out with a resorption of the fluid in the sorption material. The invention also relates to a device for controlling the temperature of a battery assembly, comprising a sorption heat storage means that is thermally coupled to the battery assembly and having a fluid and a sorption material, wherein the battery assembly is designed as a heat source for thermally heating the sorption material contained in the sorption heat storage means for the desorption of the fluid, and wherein the sorption heat storage means is designed as a heat source for an independent heating of the battery via a resorption of the fluid in the sorption material.

The invention relates to a method for controlling the temperature of a battery assembly according to claim 1, and a device for controlling the temperature of a battery assembly according to claim 6.

At present, battery assemblies, in particular for automobiles and other motor vehicles, are gaining more and more particular interest. In this case, preponderantly battery arrangements of high energy density such as lithium ion batteries, for example, are used. Such battery arrangements are intended to allow a vehicle to be operated under any seasonal conditions as traction batteries in automobile applications.

The usual battery realizations, however, show a strong dependence of the power output and energy capacity on the temperature of the system. The optimum is here in a temperature range between 10 and 40° C. Against strong overheating at temperatures of more than 60° C., which could lead to a destruction of Li ion cells, electronic management systems are used, against low temperatures of less than 10° C., which dramatically reduce the output due to an increase of the internal resistance, only a heating of the batteries is of help.

The task is therefore to design the operation of such battery assemblies in an efficient manner and to keep the battery assemblies in the optimum temperature range under variable conditions of use by efficient means.

The task is solved by a method for controlling the temperature of a battery assembly having the features of claim 1, and by a device for controlling the temperature of a battery assembly having the features of claim 2.

In the method for controlling the temperature of a battery assembly, the battery assembly is thermally coupled to a sorption heat storage means. In a desorption phase of the sorption heat storage means, a heating of the sorption material occurs with a desorption of a fluid during a heat output of the battery assembly during an electrical discharging and/or electrical charging. Thereby, a cooling of the battery assembly is caused. Subsequently, a condensation of the fluid desorbed from the sorption material occurs in a condenser with a heat sink. Subsequently, the fluid is available for a new reheating process of the battery assembly. This process is carried out with the resorption of the fluid in the sorption material. The resorption heat released on this occasion causes the battery assembly to be heated independently.

In a further configuration, the desorption of the fluid is performed during the electrical charging of the battery assembly, wherein the desorbed fluid outputs the condensation heat output during the condensation to an existing air-conditioning unit.

In a further configuration, during the resorption of the fluid in the sorption material, the fluid is supplied from a fluid storage means in gaseous form, wherein the evaporation heat needed for the transition into the gaseous form is extracted from a condenser of the existing air-conditioning unit.

In a further realization, the sorption heat storage means is operated by a first fluid and the existing air-conditioning unit by a second fluid, wherein the first fluid and the second fluid are different, wherein the condenser of the air-conditioning unit is applied by the fluid of the sorption heat storage means via a heat exchanger, in particular a heat pipe.

In a further configuration, the sorption heat storage means and the existing air-conditioning unit are operated by the same fluid, wherein the sorption heat storage means is switched into the circuit of the existing air-conditioning unit via a valve arrangement.

A device for controlling the temperature of a battery assembly comprises a sorption heat storage means that is electrically coupled to the battery assembly and having a fluid and a sorption material, wherein the battery assembly is designed as a heat source for thermally heating the sorption material contained in the sorption heat storage means for the desorption of the fluid.

In addition, a condenser that is thermally coupled to a heat sink may be provided for liquefying the fluid. Here, in particular cooling devices can be used as the heat sink, which are operated by the mains current already available at the charging stations, so that the condensation of the fluid may be performed at low temperatures in a very effective manner.

In one embodiment, the sorption heat storage means is formed as a plurality of adsorber elements integrated into the battery assembly, wherein the adsorber elements fill the gaps between the battery cells, wherein the adsorber elements are connected to a common vapor channel for the fluid supply.

The sorption heat storage means may also be arranged outside around the battery assembly, wherein the vapor channel contains the adsorber elements.

In the latter case, heat-conducting elements are guided out from the vapor channel starting from the adsorber elements.

According to the invention, the basic idea of the method and the device is in each case to utilize a sorption heat storage means and the processes proceeding in such a storage means for controlling the temperature of the battery and thus to temporarily store the heat emitted from the battery assembly.

The invention thus enables a controlled heating of the battery by an integrated sorption heat storage means when the vehicle starts. Thus, the performance and capacity, in particular of a lithium ion battery, may be retrieved even at low temperatures when the travel begins, without electrical energy stored for this purpose being consumed.

Moreover, the battery temperature may be reduced in the desorption step during discharging and during charging of the battery.

The method is carried out, for example, as described below, wherein the exemplary device explained hereinafter will be used.

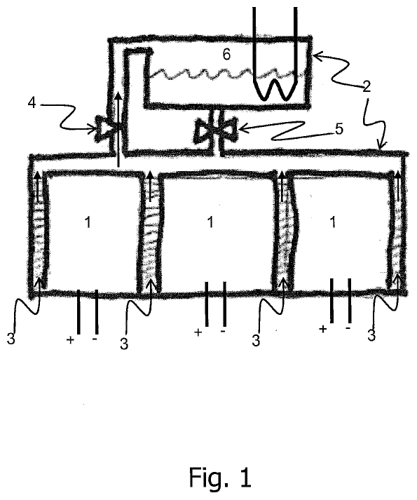

FIG. 1 shows a possible embodiment of the device in the desorption sub-step during a liquid fluid supply,

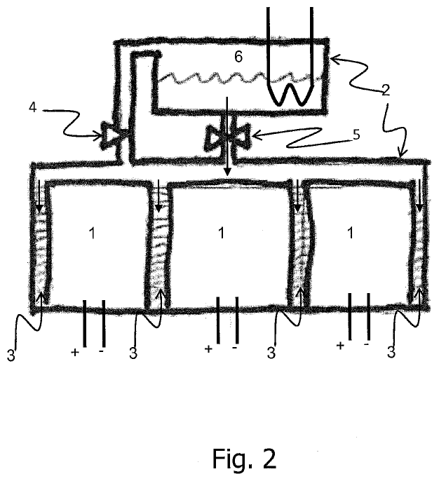

FIG. 2 shows a possible embodiment of the device from FIG. 1 in the heating sub-step during a liquid fluid supply,

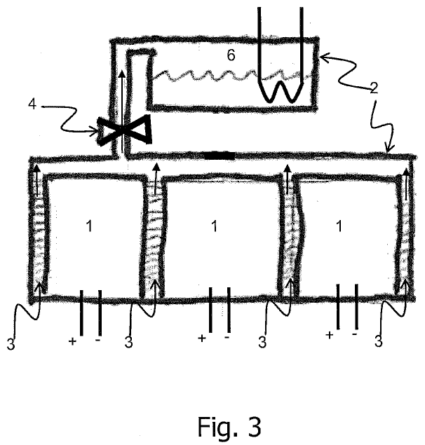

FIG. 3 shows a possible embodiment in the desorption sub-step during a gaseous fluid supply,

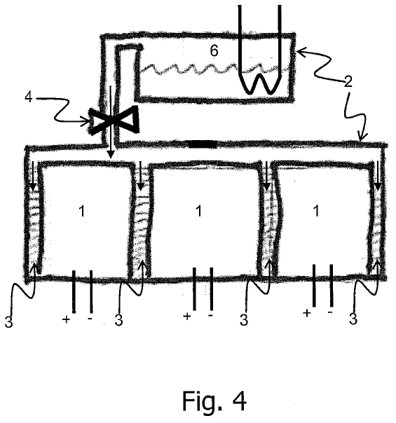

FIG. 4 shows the embodiment from FIG. 3 in the heating sub-step during a gaseous fluid supply,

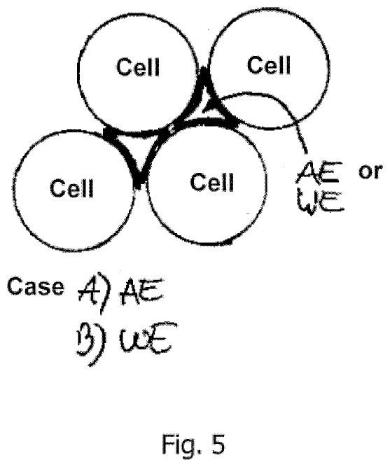

FIG. 5 shows an arrangement of adsorber elements and battery cells,

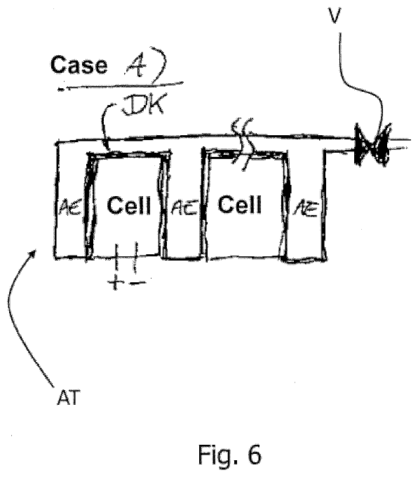

FIG. 6 shows a further view of the arrangement from FIG. 5,

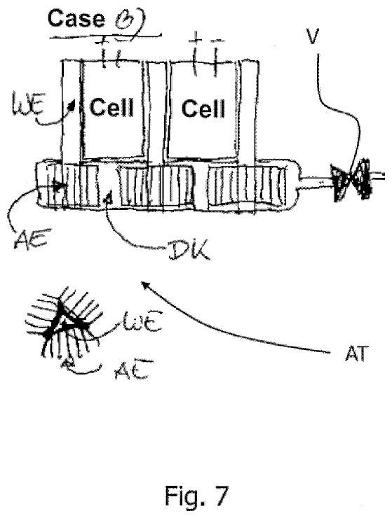

FIG. 7 shows an adsorber part situated outside of the battery assembly,

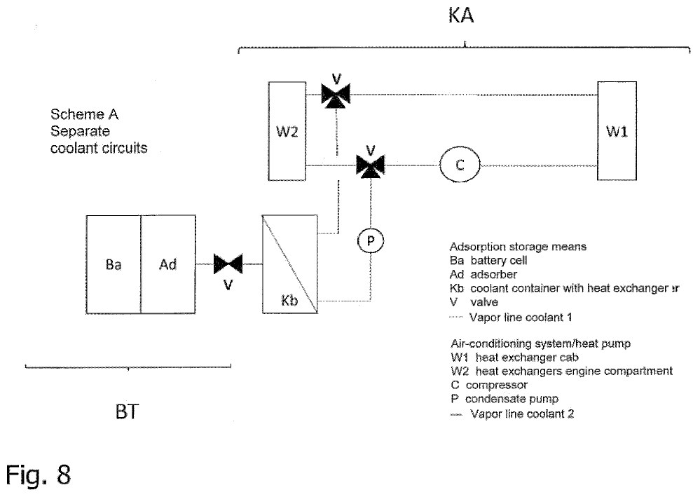

FIG. 8 shows a first coupling of the battery temperature controlling device to an air-conditioning unit,

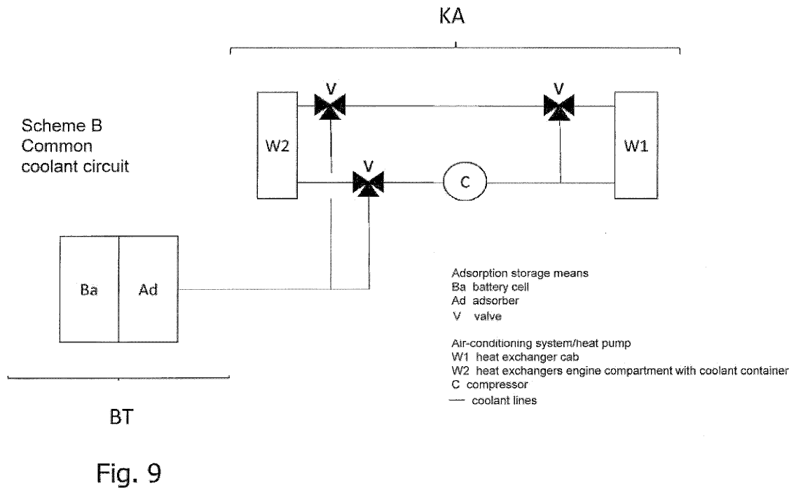

FIG. 9 shows a second coupling of the battery temperature controlling device to an air-conditioning unit.

In the battery assembly, thin, evacuated sorption units are installed by a direct thermal contact, for example, around or at each individual cell or around or at each individual battery, which sorption units are in connection to a closed vacuum sorption system via one or more valves. These sorption units act as a battery-integrated sorption heat storage means.

Outside the battery, the sorption heat storage means includes means for providing and condensing at least one fluid as a working medium of the sorption heat storage means. In the heating sub-step, the fluid is received with opened valves by the sorption units while emitting heat, whereby the temperature in the battery will then be increased to the lower limit of the optimum temperature range. If the heating of the cells is not required, the sorption units will store the heat energy with closed valves.

This process is performed reversibly. For regenerating the sorption unit, these will be heated up to 60° C. by a heat input from the battery. Hereby, a desorption of the fluid occurs, and the fluid is desorbed again in a gaseous form, condensed in the sorption system at the condenser and temporarily stored until the next heating sub-step.

Thus, the battery is the heat source for the desorption, which battery heats during the discharging in the driving operation or during the charging of the battery at the electric network to temperatures at the upper limit of the optimum temperature range, i.e. in particular at a maximum of 60° C. The desorption of the fluid from the sorption units extracts heat energy from the battery and thus additionally cools the battery. This enables a more rapid energy output in the driving operation or more rapid charging processes at the charging station.

At the charging station, a simple conventional cooling device such as e.g. a cab cooling system may serve as a heat sink for the condenser and be operated by energy from the electric network, so that the condensation of the fluids may become possible at very low temperatures of less than 0° C., for example.

The method and the device thus enable controlled temperature management in particular of traction batteries without any additional energy withdrawal from the traction batteries which goes beyond a mere regulation of the entire operation. The batteries may in particular be heated independently at low outdoor temperatures without being connected to an external electric network or another energy source. Therewith, sufficient battery power and capacity is rapidly available even at low outdoor temperatures.

Without the risk of damage, the batteries may be discharged at temperatures of less than 10° C. Overheating events of the battery assembly at temperatures of in particular more than 60° C. may be avoided.

At higher outdoor temperatures, the activated sorption units may moreover contribute to the cab air-conditioning in the vehicle.

A part of the necessary energy may moreover be recovered by a thermal recuperation from the discharging heat of the batteries, a further part may be recovered at the charging of the traction batteries form the heating thereof. The remaining energy is taken from the electric network at the charging station.

The sorption units may also be realized as the outer insulation of the battery assembly.

The following possible sorbents may be used for the sorption material: microporous or mesoporous materials such as zeolites and zeolitic materials, porous oxides and mixed oxides, porous materials on the basis of organic linker molecules such as MOF, salt-impregnated porous solids, activated carbons, hydrophilic or aminophilic solutions.

As the fluid and working medium and thus as a possible adsorptive agent or absorptive agent, for example, water, methanol or ammoniac may be used either in a pure form but also as mixtures.

On the condenser side, substance mixtures may also be employed. Here, it is in particular possible to evaporate the fluid at very low temperatures from solutions or mixtures with additives lowering the melting point, e.g. ionic liquids, salts or antifreeze agents, such as in particular ethylene glycol.

The thermal sorption heat storage means may be realized in its construction, for example, as a separator within a battery cell of the battery assembly, as an outer envelope in each case around individual battery cells, as an outer envelope around a battery block of the battery assembly, and/or also as an outer envelope around the entire battery assembly itself. Apart from the heat storage, it may therefore have a double benefit for the insulation and segment separation between multiple cells in the battery assembly.

Possible other applications of the method and the therefor used device may also be heating and/or cooling of the battery during the travel as well as the support of heating and/or cooling of the cabin space of the vehicle itself.

FIG. 1 shows a possible embodiment of the device in the desorption sub-step during a liquid fluid supply. Here, a battery assembly of battery cells (1) having a sorption heat storage means is provided. This sorption heat storage means includes a sorption system (2) with sorption units (3), valves (4) and (5), as well as a condenser (6) with the condensed fluid and a cooling unit (7). The cooling unit (7) acts as a heat sink for the fluid desorbed from the sorption unit (3) by the heat supplied by the battery cells. The valve (4) is opened in this case. The return path from the condenser via the valve (5) is closed. Here, the condenser acts moreover as a reservoir and temporary storage means for the liquefied fluid.

FIG. 2 shows a possible embodiment of the device in the heating sub-step during a liquid fluid supply. Here again, the sorption system (2) including the sorption units (3) are shown with the battery cells (1). Here, the valve (4) is closed. The liquid fluid is returned from the condenser (6) into the sorption units (3) via the opened valve (5). During the resorption of the fluid in the sorption units, heat is released. This heat serves to heat the battery cells independently to the optimum temperature range.

FIG. 3 shows a possible embodiment of the device in the desorption sub-step during a gaseous fluid supply. Here, as well, a battery assembly of battery cells (1) is provided. The sorption heat storage means comprises the sorption system (2) with the sorption units (3) and the valve (4). Here, the condenser (6) with the condensed fluid and the cooling un it (7) is likewise provided as a heat sink. The fluid is desorbed from the sorption units by heat emission from the battery cells and liquefied in the condenser at a low temperature. Here again, the condenser serves as a temporary storage means for the liquefied fluid. Thereafter, the valve (4) is closed. After completion of the condensation process, the fluid heats up in the interior space of the condenser.

FIG. 4 shows the embodiment from FIG. 3 in the heating sub-step during a gaseous fluid supply. The fluid temporarily stored in the condenser (6) passes over into the gaseous phase again at latest when the valve (4) is opened. Via the opened valve (4), it is thus returned in gaseous form into the sorption units (3) of the sorption system (2) and will be resorbed there. Hereby, heat is released which is output to the battery cells (1) and heats these independently to an optimum temperature range.

The target is in any case to achieve a good thermal coupling to the individual cells at a low constructional volume and good vapor accessibility. FIGS. 5 and 6 show corresponding exemplary embodiments.

In the embodiment shown in FIG. 6, adsorber elements (AE) fill the free spaces between circular battery cells (Cell) with a wall contact to the cells.

The vapor entry is here performed from above or below via a two-dimensional or linear common vapor channel (DK) for a plurality of adsorber elements, as shows the representation in FIG. 6. The vapor channel (DK) and the adsorber elements (AE) together constitute the adsorber part (AT) in the battery assembly.

Via a valve (V), the vapor channel is individually or with further vapor channels connected to an evaporator/condenser unit not illustrated here.

The adsorber parts may be integrated into the battery assembly during the assembly of the individual cells. The adsorber elements are in contact with the adsorbent in an appropriate manner on the inner side conducting the vacuum.

In a further configuration shown in FIG. 7, the adsorber part is in contact outside of the battery assembly, ideally directly below or above the battery assembly.

The adsorber parts in the example present here are situated in the vapor channel (DK). From the adsorber elements (AE) and in direct thermal contact to the adsorber elements, suitable heat-conducting elements (WE) such as metallic structures or heat pipes extend from the vapor channel.

Via a valve, the vapor channel is individually or with further vapor channels connected to an evaporator/condenser element not shown here. The vapor channel (DK) and the adsorber element (AE) together with the heat-conducting element constitute the adsorber part (AT) in the battery assembly. The heat-conducting elements fill the free spaces between the battery cells with a wall contact to the cells.

The adsorber elements consist of a metallic structure arranged around the heat-exchanging elements and appropriately contacted to the adsorbent. The structure of the adsorber elements should offer a high upper surface for the contact to the adsorbent, i.e. to the employed fluid. In the adsorption event, the heat released in the adsorber element is introduced into the battery assembly via the heat-conducting elements.

In the case of liquid fluids, these can be in various operational phases at various positions of the vacuum system within or without the battery assembly. For this purpose, an active conveyance of the liquid sorbents may also be performed.

Integrating the adsorption heat storage means into the thermal management of the motor vehicle is in particular also possible. The target is a simple integration of the adsorption storage means into the vehicle, in particular using an existing compressor-operated air-conditioning system or a heat pump for supporting the charging and discharging of the battery system. FIG. 8 and FIG. 9 show corresponding examples.

The mode of operation and the corresponding structure are as follows:

The battery temperature control device BT is composed of a battery assembly, in particular at least one battery cell Ba, and an adsorber Ad thermally coupled to the battery cell Ba.

In the embodiment of FIG. 8, the battery temperature control device BT and the air-conditioning system KA are structurally separate from one another. In this case, the fluids in the battery temperature control device and in the air-conditioning system are in particular different, but are in thermal contact via a coolant container Kb, so that heat may be exchanged in this place.

First, charging of the adsorption storage means is performed during the battery charging: desorption heat is provided by the exhaust heat of the battery during its charging. The condensation heat is discharged by the existing air-conditioning system KA and output, for example, toward the driver's cabin of the engine compartment via heat exchangers W1 and W2. For the circulation of the coolant performed in the air-conditioning system, a compressor C and a condensate pump P as well as a series of valves V are provided there.

Discharging of the storage means for the fluid is performed for pre-heating the battery: the adsorption heat released in this case heats the battery. The required evaporation heat is supplied by the existing condenser within the existing air-conditioning system, which condenser is operated in this case as an evaporator within the sorption heat storage means.

If two different coolants are used as in FIG. 8 for the adsorption heat storage means, i.e. in the area of the battery temperature control device BT and the air-conditioning system KA, the condenser will be applied with the coolant by a coolant pump or a capillary line following the heat pipe principle.

For simplifying the integration, the adsorption storage means, i.e. the battery temperature control device BT and the air-conditioning system KA may be operated by the same coolant, preferably by carbon dioxide as the coolant, as shown in FIG. 9. The fluid from the battery temperature control device.

### LIST OF REFERENCE NUMERALS

1 battery cell

2 sorption system

3 sorption unit

4 first valve

5 second valve

6 condenser and temporary fluid storage means

7 cooling unit as heat sink

AE adsorber element

AT adsorper part

Cell battery cell

DK vapor channel

AT adsorber part

V valve

WE heat-conducting element

BT battery temperature control device

Ba battery cell

Ad adsorber

KA air-conditioning system

Kb coolant container

W1, W2 heat exchangers

C compressor

P condensate pump

1. A method for controlling the temperature of a battery assembly,
wherein
the battery assembly is thermally coupled to an integrated sorption heat storage means,
wherein
thin, evacuated sorption units are installed by a direct thermal contact around or at each individual cell of the battery assembly or around or at each individual battery of the battery assembly, which sorption units are in connection to a closed vacuum sorption system via one or more valves, wherein the sorption units act as a battery-integrated sorption heat storage means,
and wherein
in a desorption phase of the sorption heat storage means, heating of the sorption material by desorbing a fluid during a heat output of the battery assembly is performed during electrical discharging and/or electrical charging,
condensation of the fluid desorbed from the sorption material is performed in a condenser with a heat sink, wherein
in the case of a required resorption of the fluid in the sorption material, independent heating of the battery may be executed by means of the released resorption heat, wherein
during the electrical charging of the battery assembly, the desorption of the fluid is performed, wherein the desorbed fluid outputs the condensation heat output during the condensation to an existing air-conditioning unit,
during the resorption of the fluid in the sorption material, the fluid is supplied from a fluid storage means in gaseous form, wherein the evaporation heat needed for the transition into the gaseous form is extracted from a condenser of the existing air-conditioning unit.

2. (canceled)

3. (canceled)

4. The method according to claim 1,
characterized in that
the sorption heat storage means is operated by a first fluid and the existing air-conditioning unit by a second fluid, wherein the first fluid and the second fluid are different, wherein the condenser of the air-conditioning unit is applied by the fluid of the sorption heat storage means via a heat exchanger, in particular a heat pipe.

5. The method according to claim 1,
characterized in that
the sorption heat storage means and the existing air-conditioning unit are operated by the same fluid, wherein the sorption heat storage means is switched into the circuit of the existing air-conditioning unit via a valve arrangement.

6. A device for controlling the temperature of a battery assembly,
comprising
a sorption heat storage means that is electrically coupled to the battery assembly and having a fluid and a sorption material, wherein the battery assembly is designed as a heat source for thermally heating the sorption material contained in the sorption heat storage means for the desorption of the fluid, and wherein the sorption heat storage means is designed as a heat sink for heating the battery independently by a resorption heat released in the sorption material by a resorption of the fluid in the sorption material.

7. The device according to claim 6,
characterized in that
a condenser coupled to a heat sink is provided for liquefying the fluid.

8. The device according to claim 6,
characterized in that
the sorption heat storage means is formed as a plurality of adsorber elements integrated into the battery assembly, wherein the adsorber elements fill the gaps between the battery cells, wherein the adsorber elements are connected to a common vapor channel for the fluid supply.

9. The device according to claim 6,
characterized in that
the sorption heat storage means is arranged outside around the battery assembly, wherein the vapor channel contains the adsorber elements.

10. The device according to claim 6,
characterized in that
heat-conducting elements are guided out from the vapor channel starting from the adsorber elements.
